(19) United States
(12) Patent Application Publication
(10) Pub. No.: US 2018/0339195 A1
(43) Pub. Date: Nov. 29, 2018

(54) Exercise Information System

(71) Applicant: Erik A. Bernotas, Norwalk, CT (US)

(72) Inventor: Erik A. Bernotas, Norwalk, CT (US)

(21) Appl. No.: 15/990,116

(22) Filed: May 25, 2018

Related U.S. Application Data
(60) Provisional application No. 62/510,844, filed on May 25, 2017.

(51) Int. Cl. A63B 24/00; H04N 7/14; G06T 11/00; A63B 21/22; A63B 22/00; A63B 71/06

(52) U.S. Cl. CPC A63B 24/0075; A63B 2024/0081; G06T 11/00; A63B 21/225; A63B 22/0076; A63B 24/0006; A63B 24/0062; A63B 71/0622; A63B 24/0084; A63B 2022/0079; A63B 2024/0015; A63B 2024/0068; A63B 2071/0647; A63B 2071/0658; A63B 2220/05; A63B 2220/806; A63B 2220/83; A63B 2225/20; A63B 2225/50; A63B 2071/065; A63B 2024/0009; H04N 7/142

(57) ABSTRACT

A system and method for providing exercise instruction through a multi-video simultaneous streaming device. The system includes an exercise machine; a processor connected to the exercise machine; a memory, at least one camera, and a display screen connected to the processor; and software instructions to receive multiple video feeds and display the video feeds simultaneously. The method includes capturing a video feed of a user operating the exercise machine, communicating the video feed of the user to a first user device connected to the exercise machine, capturing a video feed of an instructor operating another exercise machine, communicating the video feed of the instructor to the first user device, and displaying the video feeds simultaneously on a display screen of the first user device.

### CROSS-REFERENCE TO RELATED APPLICATIONS

The present application claims priority to, and incorporates by reference herein, U.S. Provisional Patent Application No. 62/510,844 filed on May 25, 2017.

### FIELD OF THE INVENTION

The present invention is in the field of exercise instruction. Specifically, the present invention relates to systems and methods for providing exercise instruction through a multi-video simultaneous streaming device.

### BACKGROUND OF THE INVENTION

The use of indoor exercise machines continues to increase as more people desire the benefits resulting from regular exercise. People use these machines in gyms, health clubs, and their homes. However, using exercise machines without proper instruction risks sub-optimal health benefits and serious injury.

For example, indoor rowing is a highly efficient form of exercise. By working both the upper and lower body, indoor rowing machines provide users with both cardiorespiratory and strength training benefits. However, rowing is not an exercise that comes naturally to most people, as rowing is not an activity most kids grow up doing. Hence, rowing form is often misunderstood to be primarily an arm and rear deltoid exercise. This rowing form neglects the legs and risks lower back injury.

Proper rowing form is necessary for rowers to receive maximum health benefits, prevent injury, and enable success. Rowing clubs and programs typically use portable mirrors for rowers to see their form and implement changes based on instructional cues from their coaches. Although portable mirrors can be helpful, they require rowers to turn their heads to the side to watch themselves in the mirror. This is not an optimal position because turning to the side for extended periods strains the neck, resulting in discomfort and a risk of neck injury. Rather, rowers would benefit most from being able to see their side profiles directly in front of them, thus, enabling stroke optimization and cadence synchronicity without the strain and discomfort of regularly turning to their sides for instruction.

What is needed, therefore, is a system and method for providing exercise instruction through a multi-video simultaneous streaming device. Such a system and method should permit users of exercise machines to see a real-time video feed of their side profile alongside a video feed of an instructor's side profile performing the same exercise.

### SUMMARY OF THE INVENTION

Accordingly, embodiments of the present invention include systems and methods for providing exercise instruction through a multi-video simultaneous streaming device. As used herein, the terms “monitor,” “client monitor,” “user device,” and “instructor-input terminal” refer to various embodiments of the multi-video simultaneous streaming device of the invention. Additionally, the term “system,” as used herein, describes various embodiments of the invention implementing the multi-video simultaneous streaming device, such as a system describing the individual components of the multi-video simultaneous streaming device, and a system describing the multi-video simultaneous streaming device as a whole in communication with external devices.

In one embodiment of the invention, a system for providing instructional training to a user operating an exercise machine including a processor connected to the exercise machine, a display screen connected to the processor, a memory connected to the processor, and at least one camera connected to the processor is provided. The processor includes software instructions to receive from the at least one camera a side profile view video feed of the user; receive, either from the memory or from a server in communication with the system via a network, a side profile view video of an instructor operating a second exercise machine; and display the side profile view video feed of the user and the side profile view video of the instructor simultaneously on the display screen.

In some embodiments, the processor further includes software instructions to receive from the at least one camera a front view video feed of the user, and display the front view video feed of the user, the side profile view video feed of the user, and the side profile view video feed of the instructor simultaneously on the display screen.

In some embodiments, the processor further includes software instructions to receive exercise form correction cues from an instructor, render the exercise form correction cues as a graphical overlay, and display the graphical overlay on the displayed side profile view video feed of the user.

In some embodiments, the processor further includes software instructions to analyze the user's exercise form and the instructor's exercise form, generate exercise form correction cues, render the exercise form correction cues as a graphical overlay, and display the graphical overlay on the side profile view video feed of the user.

In some embodiments, the processor further includes software instructions to receive performance data from the exercise machine; receive, either from the memory or from the server; performance data from each of a plurality of exercisers operating respective exercise machines; organize the user and the plurality of exercisers into teams; and calculate team performance data for each team.

In some embodiments, the processor further includes software instructions to receive, either from the memory or from the server, side profile view videos of the user's teammates, and display the side profile view video feed of the user, the side profile view videos of the users teammates, and the side profile view video of the instructor simultaneously on the display screen.

In some embodiments, the processor further includes software instructions to calculate a comparison of each team's team performance data, render the comparison as a graphically simulated race, and display the graphically simulated race on the display screen.

In an alternative embodiment of the invention, a system for providing live exercise instruction including an instructor-input terminal and one or more servers configured for coordinating communication via a network between the instructor-input terminal and at least one client monitor is provided. The system also includes software executing on the one or more servers, containing instructions to receive a side profile view video feed of an exerciser from the at least one client monitor as captured by at least one camera associated with the at least one client monitor, transmit a side profile view video feed of the instructor to the at least one client monitor, display the side profile view video feed of the exerciser and the side profile view video feed of the instructor simultaneously on a display screen of the instructor-input terminal, receive exercise form correction cues, and transmit the exercise form correction cues to the at least one client monitor.

In some embodiments, the at least one client monitor includes software instructions to receive the side profile view video feed of the exerciser; receive a front view video feed of the exerciser as captured by the at least one camera associated with the client monitor; receive the side profile view video feed of the instructor; and display the front view video feed of the exerciser, the side profile view video feed of the exerciser, and the side profile view video feed of the instructor simultaneously on a display screen of the client monitor.

In some embodiments, the exercise form correction cues are received from the instructor-input terminal after being input by an instructor. Also, the software further includes instructions to render the exercise form correction cues as a graphical overlay and transmit the graphical overlay to the at least one client monitor for display on the side profile view video feed of the exerciser.

In some embodiments, the software further includes instructions to analyze the exerciser's exercise form and the instructor's exercise form, generate exercise form correction cues, render the exercise form correction cues as a graphical overlay, and transmit the graphical overlay to the at least one client monitor for display on the side profile view video feed of the exerciser.

In some embodiments, the software further includes instructions to receive performance data from each of a plurality of client monitors, receive side profile view video feed of exercisers from each of the plurality of client monitor, organize the exercisers into teams, and calculate team performance data for each team.

In some embodiments, each of the plurality of client monitors includes software instructions to receive the side profile view video feed of the respective exerciser, receive the side profile view video feed of the respective exerciser's teammates, receive the side profile view video feed of the instructor, and display the side profile view video feeds of the respective exerciser, the respective exerciser's teammates, and the instructor simultaneously on a display screen of the client monitor.

In some embodiments, each of the plurality of client monitors further includes software instructions to receive each team's team performance data, calculate a comparison of each team's team performance data, render the comparison as a graphically simulated race; and display the graphically simulated race on the display screen of the client monitor.

In some embodiments, the software further includes instructions to receive performance data from each of a plurality of client monitors, receive side profile view video feeds of exerciser from each of the plurality of client monitors, and assign each exerciser at least one race opponent exerciser. Each of the plurality of client monitors includes software instructions to receive the side profile view video feed of the respective exerciser; receive the side profile view video feed of the respective exerciser's at least one race opponent exerciser; receive the side profile view video feed of the instructor; display the side profile view video feeds of the respective exerciser, the respective exercisers at least one race opponent exerciser, and the instructor simultaneously on a display screen of the client monitor; receive the performance data of the respective exerciser's at least one race opponent exerciser; calculate a comparison of the performance data of the respective exerciser and the respective exerciser's at least one race opponent exerciser; render the comparison as a graphically simulated race; and display the graphically simulated race on the display screen of the client monitor.

In another embodiment of the invention; a method of providing instructional training to a user of a first exercise machine participating in a live exercise class is provided. The method includes the steps of capturing a side profile view video feed of the user operating the first exercise machine, communicating the side profile view video feed of the user to a first user device connected to the first exercise machine, capturing a side profile view video feed of an instructor operating a second exercise machine, communicating the side profile view video feed of the instructor to the first user device, and displaying the side profile view video feed of the user and the side profile view video feed of the instructor simultaneously on a display screen of the first user device.

In some embodiments, the method also includes the steps of capturing a front view video feed of the user operating the first exercise machine; communicating the front view video feed of the user to the first user device; and displaying the front view video feed of the user, the side profile view video feed of the user, and the side profile view video feed of the instructor simultaneously on the display screen of the first user device.

In some embodiments, the method also includes the steps of receiving exercise form correction cues on the first user device, rendering the exercise form correction cues as a graphical overlay, and displaying the graphical overlay on the displayed side profile view video feed of the user.

In some embodiments, the method also includes the steps of analyzing the users exercise form and the instructor's exercise form, generating exercise form correction cues, rendering the exercise form correction cues as a graphical overlay, and displaying the graphical overlay on the displayed side profile view video feed of the user.

In some embodiments, the user is remotely located from the instructor.

### BRIEF DESCRIPTION OF THE DRAWINGS

FIG. 1 is a rear perspective view of an exercise information system according to a first embodiment of the invention.

FIG. 2 is a front view of a user device displaying simultaneous side profile view videos and performance data according to a second embodiment of the invention.

FIG. 3 is a front view of the user device of FIG. 2 further displaying a graphical exercise form correction overlay.

FIG. 4 is a front view of the user device of FIG. 3 displaying a user's exercise form correctly matching the graphical overlay.

FIG. 5 is a front view of the user device of FIG. 2 further displaying additional simultaneous side profile view videos and performance data associated with a simulated race.

FIG. 6 is a front view of the user device of FIG. 2 further displaying a front view video simultaneously with the side profile view videos.

FIG. 7 is a schematic of the hardware associated with the user device of FIG. 2.

### DETAILED DESCRIPTION OF THE INVENTION

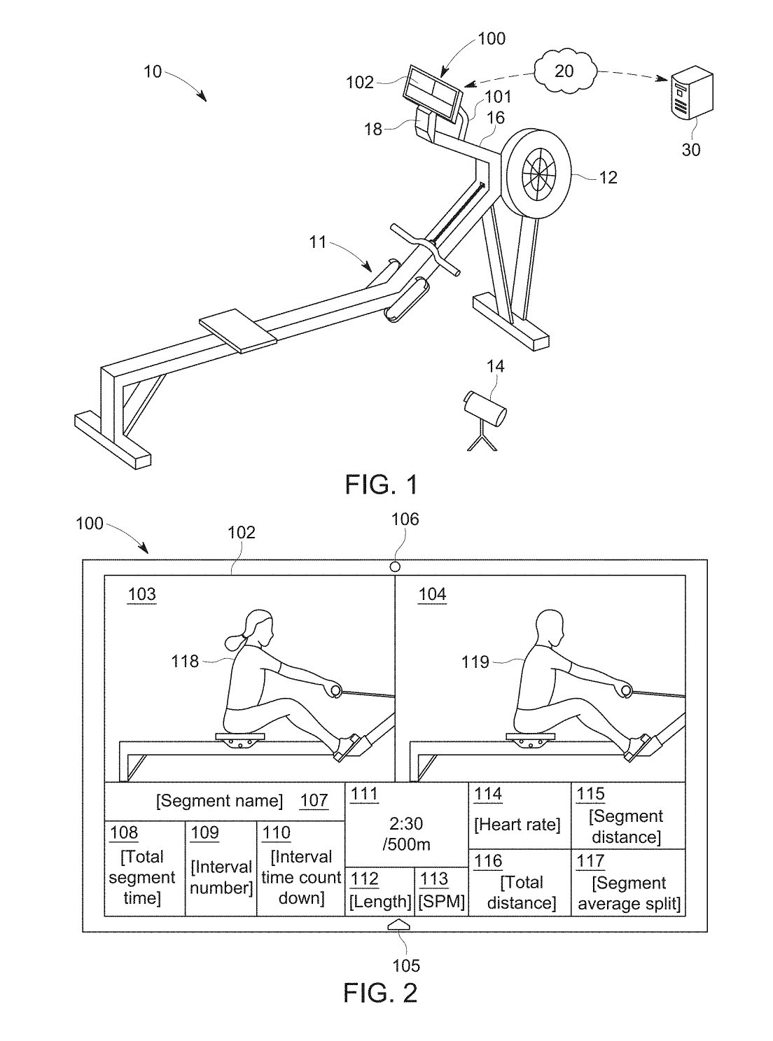

The figures show exemplary embodiments of the present invention. In FIG. 1, a system for exercise instruction 10 is shown. In preferred embodiments, system 10 has an exercise machine 11. Although exercise machine 11 is shown as a rowing machine, the invention contemplates use of any exercise machine, such as a treadmill, a skiing machine, an exercise bike, a stepping machine, or an orbital stepping machine. Exercise machine 11 includes operating component 12, depicted in FIG. 1 as a flywheel, but the invention contemplates use of any operating component, such as a motor, a conveyor, a wheel, or a magnetic arrangement. In some embodiments, exercise machine 11 has an arm 16 and a computer 18 connected to an end of the arm 16. The computer 18 is configured to obtain performance data from the operating component 12.

FIG. 1 also shows a monitor 100 attached to exercise machine 11. In preferred embodiments, monitor 100 is a portable computing device, such a tablet, mobile telephone, or laptop computer. In some embodiments, monitor 100 is a fixed computing device, such as a desktop computer, smart TV, connected TV, or hybrid TV.

In preferred embodiments, monitor 100 attaches to arm 16, computer 18, or any other part of exercise machine 11, provided that a user exercising on exercise machine 11 can view the monitor 100 without having to turn her head to one side. In some embodiments, monitor 100 is removeably attached to exercise machine 11. In other embodiments, monitor 100 is permanently attached to exercise machine 11. In preferred embodiments, monitor 100 permits vertical adjustment to accommodate users of various heights. Vertical adjustment is accomplished through any known means, such as telescoping members or a flexible gooseneck member 101. In some embodiments, monitor 100 permits articulating movement so it can face a user when the attachment point is not in front of the user. Articulating movement is accomplished through any known means, such as a ball-in-socket pivot joint or a flexible gooseneck member 101.

In preferred embodiments, monitor 100 is in communication with computer 18 for receiving the performance data and displaying it to a user on display screen 102 of monitor 100. In some embodiments, exercise machine 11 does not include computer 18, and monitor 100 receives the performance data through communication with operating component 12 of exercise machine 11. In preferred embodiments, monitor 100 connects to a server 30 through a network 20. Through this connection, monitor 100 can communicate information to the server 30, such as the performance data received from the exercise machine 11. Additionally, monitor 100 can communicate with other monitors connected to server 30. Thus, monitor 100 can send information to and receive information from other monitors, such as performance data, video feeds, and audio signals.

FIG. 1 also depicts a camera 14 positioned laterally to exercise machine 11. Preferably, camera 14 is positioned to capture a side profile view video feed of a user operating exercise machine 11. Camera 14 is connected to monitor 100, through either a wired or wireless connection, to communicate the side profile view video feed to monitor 100 for real-time display on display screen 102. In preferred embodiments, camera 14 is a high definition camera, such as the Logitech HD Pro WebCam c920.

FIGS. 2-5 depict the monitor 100 displaying information on a plurality of windows of display screen 102. Displayed on a first of the plurality of windows 103 is the side profile view video feed of a user 118 operating exercise machine 11 captured by camera 14 and communicated to monitor 100. Displayed on a second of the plurality of windows 104 is a side profile view video of an instructor 119 operating a separate exercise machine. The side profile view video of the instructor is also captured by a camera 14. Preferably, the side profile view video of the instructor is a feed captured by a camera 14, communicated to a monitor 100, and communicated over network 20 to server 30. The server 30 communicates the side profile view video feed of the instructor to the user's monitor 100 for display on window 104. In some embodiments, the user and the instructor are located locally, such as in a live exercise class. In other embodiments, the user is remotely located from the instructor, such as at home. In some embodiments, the side profile view video of the instructor is stored in monitor 100 so the user can receive exercise instruction at any time.

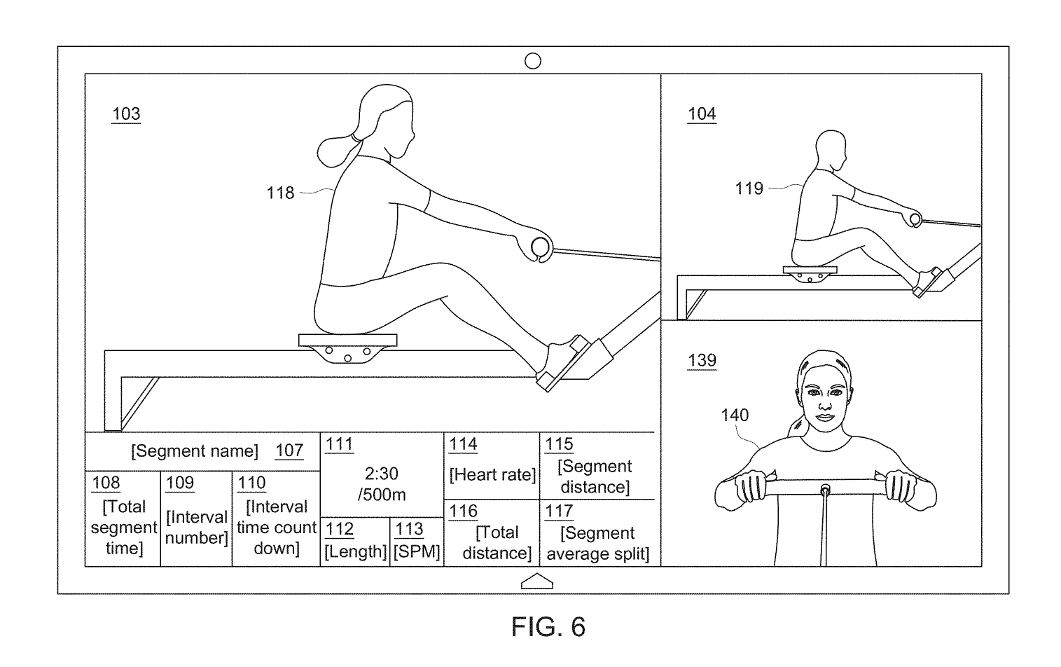

In some embodiments of the present invention, monitor 100 includes a camera 106, as depicted in FIGS. 2-5. Camera 106 is positioned to capture a front view video feed of user 140, which can be displayed in real-time in a third of the plurality of windows 139, as shown in FIG. 6. In some embodiments, 140 is a front view video feed of the instructor. In some embodiments, monitor 100 displays performance data 107-117, as depicted in FIGS. 2-4. The performance data is received from exercise machine 11, communicated from another monitor through the network connection to server 30, stored in a memory of monitor 100, obtained from an external storage device, or any combination of the preceding possibilities. For example, FIGS. 2-4 show performance data 107-110 communicated from the instructor's monitor, and performance data 111-117 received from computer 18 of exercise machine 11. The specific performance data displayed will vary depending on the exercise machine used. For example, the rowing machine depicted in FIGS. 1-5 provides performance data including, but not limited to, 500 meter split time 111 stroke length 112, strokes per minute 113, user heart rate 114, exercise segment distance 115, total distance 116, and exercise segment average split time 117. In some embodiments, monitor 100 receives from the instructor's monitor performance data including, but not limited to, exercise segment name 107, total exercise segment time 108, interval number 109, and interval time count down 110.

Monitor 100 also permits a user to control which information is displayed and how the displayed information is organized. In preferred embodiments, display screen 102 includes a touch screen, permitting the user to control the displayed information through various touch commands. For example, the user can swap the displayed video windows by touching and dragging one video window to the position of another video window. The user can enlarge or reduce the size of a video window through a multi-finger spreading or pinching command. Additionally, the user can hide, or minimize, specific performance data windows by tapping on the individual windows.

In some embodiments, monitor 100 includes a home button 105, which the user can press to control the displayed information. The user can hide, or minimize, a predetermined amount of performance data windows by pressing home button 105 once. For example, one press of home button 105 can hide all performance data windows except for 500 meter split time 111. By pressing home button 105 a second time, the user can magnify the video feed displayed in the first of the plurality of windows 103, otherwise known as the Primary Position. Also, the user can press the home button 105 a third time to revert display screen 102 to the original, fully-displayed information.

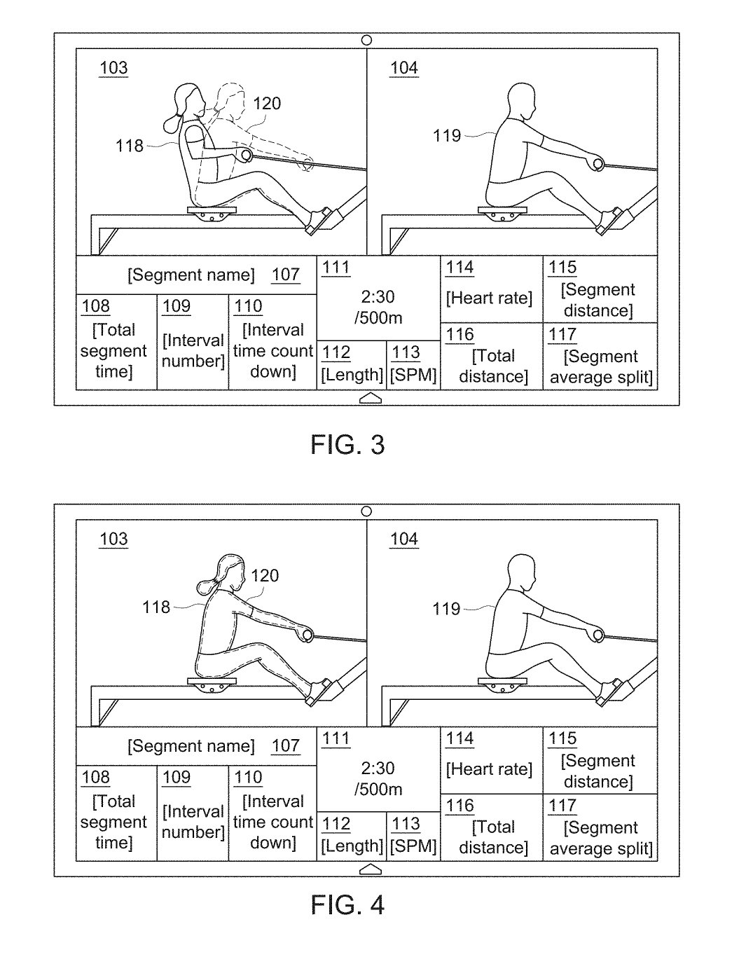

With monitor 100 displaying side profile view video feeds of the user and the instructor, the user can synchronize her exercise cadence with the instructor's exercise cadence to compare her exercise form to the instructor's form and make any necessary exercise form corrections to achieve the optimal exercise form while looking straight ahead. In preferred embodiments, if the user requires further instruction for correcting her exercise form, monitor 100 displays an instructional graphical overlay 120, as depicted in FIGS. 3-4, which comprises form correction cues.

In preferred embodiments, instructional graphical overlay 120 is generated by monitor 100. In some embodiments, monitor 100 is programmed to execute a form optimization algorithm that analyzes the user's side profile view video feed to determine the users physical measurements, such as height, torso length, inseam, foot size, and arm length, and renders graphical overlay 120 as a virtual avatar that matches the user's physique. In some embodiments, the virtual avatar is a dashed humanoid outline, as seen in FIGS. 3-4. In other embodiments, the virtual avatar is a stick figure. Next, the form optimization algorithm analyzes the instructor's side profile view video to determine an optimal exercise form. The algorithm then compares the user's exercise form to the instructor's form and determines the variances between the forms. If the exercise form variances exceed a predetermined threshold, the algorithm calculates exercise form correction cues intended to reduce the variances when followed by the user. The allowable variance threshold varies depending on the exercise performed. For example, a user exercising on a rowing machine who pulls with her arms before pulling with her legs will exceed the variance threshold, resulting in the display of graphical overlay 120, as seen in FIG. 3.

The exercise form correction cues are then rendered as graphical overlay 120, which is displayed over the user's side profile view video feed. In some embodiments, graphical overlay 120 is programmed as an animation exercising with the optimal exercise form. Thus, the user can correct her exercise form by adjusting her form until it matches the form of graphical overlay 120, as depicted in FIG. 4. In some embodiments, graphical overlay 120 includes multiple virtual avatars of the user, one of which being the optimal form avatar and the remaining ones being “ghost” avatars of a predetermined number of the user's immediately preceding exercise strokes/repetitions. For example, in some embodiments, graphical overlay 120 includes the optimal form avatar and “ghost” avatars displaying the user's previous three strokes. Thus, the user can correct her exercise form by adjusting her form until it matches the optimal form animation, and ensure that she learns the optimal form by keeping the “ghost” avatars synced to the optimal form avatar as she continues to exercise. In other embodiments, graphical overlay 120 appears as written instructional cues with arrows indicating the specific aspect of the users form that requires correction. In other embodiments, the exercise form correction cues are simple geometric shapes, such as lines, boxes, etc., which are overlaid to show the user movement limits, body positioning, etc.

In some embodiments, the video feed of a second user (e.g., an instructor) is silhouetted over the side profile video view of the user to show with more precision how well the user is matching the instructors cadence and form.

In some embodiments, instructional graphical overlay 120 is generated by the instructor and communicated to the user's monitor for display over the user's side profile view video feed. The instructor's monitor receives the users side profile view video feed from the server 30 and displays it, enabling the instructor to view the user exercising and communicate instructional cues to the user. The instructor's monitor is programmed to receive input from the instructor and communicate the input, through the server 30, to the user's monitor, which then renders the input as graphical overlay 120. In some embodiments, the input is drawn on the touch screen by the instructor, such as an optimal form stick figure or arrows indicating flaws in the user's form. In other embodiments, the input is audio cues, which are rendered by the users monitor as words displayed over the user's side profile view video feed. In some embodiments, the instructional graphical overlay 120 is rendered by the server 30 and then communicated to the user's monitor for display. In these embodiments, server 30 is programmed to execute the previously-described form optimization algorithm to generate the exercise form correction cues that compose graphical overlay 120.

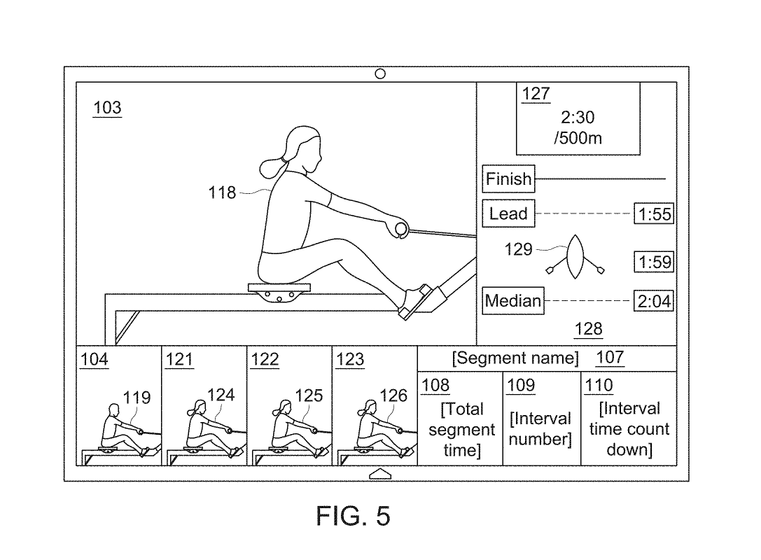

FIG. 5 depicts the monitor 100 in Race Mode. When the user is participating in a live exercise class, either locally, such as in a studio or gym, or remotely, such as at home, the instructor can initiate Race Mode. In preferred embodiments, server 30, when in Race Mode, receives the performance data from each class participant's monitor and organizes the class into teams to simulate a race. Preferably, the teams are evenly organized with respect to performance data, so the simulated race is as intense, and enjoyable, as possible. In some embodiments, server 30 receives the performance data from each class participant's monitor and assigns each participant a race opponent for a one-on-one simulated racing experience. In other embodiments, all of the participants race each other in a group race. In preferred embodiments, when in Race Mode, monitor 100 receives from server 30 the side profile view video feeds of user's teammates 124-126, which are displayed in separate windows 121-123 of display screen 102, as seen in FIG. 5. In some embodiments, when Race Mode is simulating a one-on-one race, monitor 100 receives from server 30 the side profile view video feed of the user's race opponent for display. In other embodiments, all of the participant's “boats” are shown as graphical representations on the display. In some embodiments, monitor 100 continues to receive performance data 107-110 from the instructor's monitor during Race Mode.

In preferred embodiments, as the simulated race progresses, server 30 continues to receive the performance data from each monitor and calculates team performance data 127 by averaging the performance data from each team's team members. Team performance data 127 is communicated to the monitors of that team's team members for display. The specific team performance data will vary depending on the type of exercise performed by the class. In some embodiments, when the class is exercising on rowing machines, team performance data 127 is the team's 500 meter split time, as shown in FIG. 5.

In preferred embodiments, monitor 100 receives team performance data 127 from all other teams, and calculates and renders a team performance comparison 128 for display. Team performance comparison 128 displays the users team's position relative to the team leading the race and the median position team. Preferably, the user's team is represented by an animated graphic 129, as seen in FIG. 5. In some embodiments, monitor 100 receives performance data of the user's race opponent, calculates a comparison of the users performance data and the user's race opponent's performance data, and renders the comparison as animated graphic 129 for display. Animated graphic 129 is rendered according to the exercise machines used in the race. For example, FIG. 5 shows animated graphic 129 rendered as a competitive row boat. In other embodiments, team performance comparison 128 displays animated graphics 129 for each team for further competitive simulation. In these embodiments, the user's team is distinguished from the other teams by color, shading pattern, or labeled flagging. The leading team is similarly distinguished from the other teams.

In preferred embodiments, monitor 100 displays the user's video feeds, the instructor's video feed, and, when in Race Mode, the user's teammates' video feeds, or the user's race opponent's video feed, as simultaneous lossless video feeds. This simultaneous video display is accomplished by executing software instructions. In some embodiments, the software instructions are executed by monitor 100. In some embodiments, the software instructions are executed by server 30.

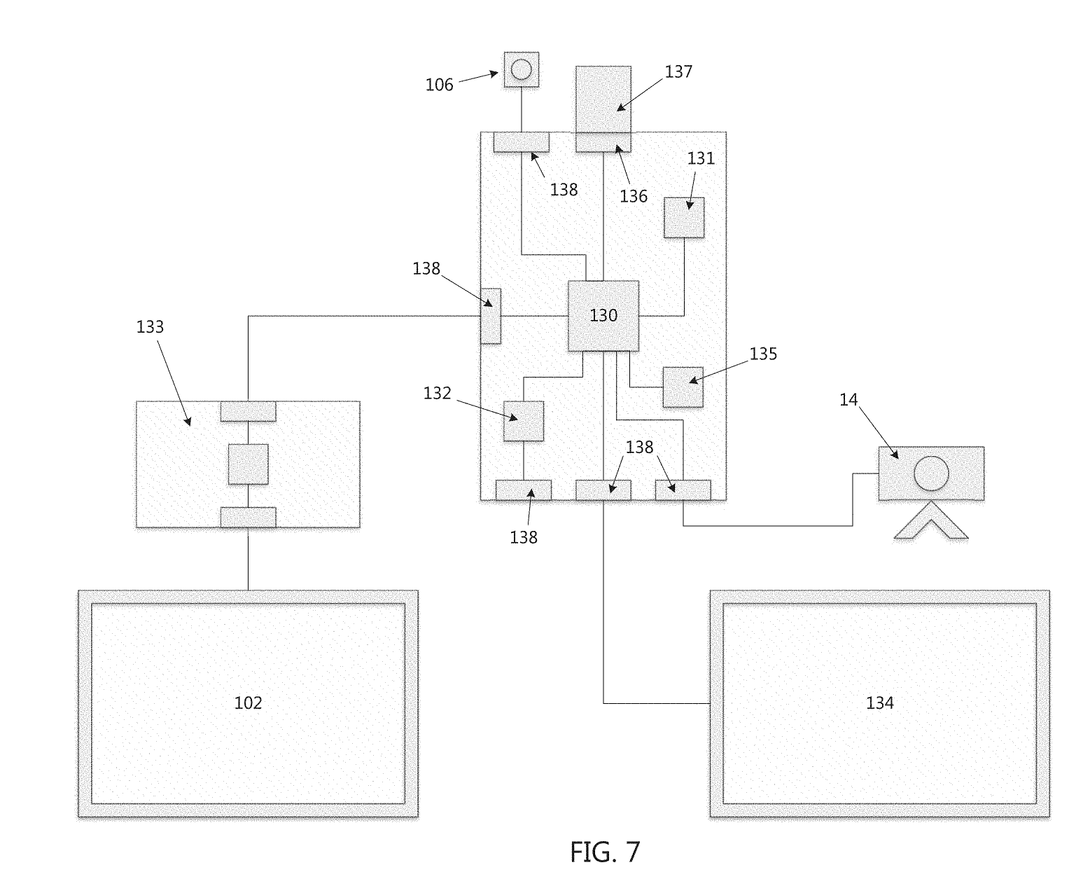

FIG. 7 shows an example of the internal components of monitor 100 used to implement the processes described above. Monitor 100 includes a processor 130, a memory 131, a display screen 102, and a communication interface 132, among other components. In some embodiments, monitor 100 is provided with a storage device, such as a microdrive or other device, to provide additional storage. Each of the components 130, 131, 102, and 132 are interconnected using various busses, and several of the components are mounted on a common motherboard or in any other appropriate manner.

The processor 130 can execute instructions within the monitor 100, including instructions stored in the memory 131. In some embodiments, the processor 130 is implemented as a chipset of chips that include separate and multiple analog and digital processors. In preferred embodiments, processor 130 provides for coordination of the other components of the monitor 100, such as control of user interfaces, applications run by the monitor 100, and wired or wireless communication by the monitor 100.

In preferred embodiments, the processor 130 communicates with a user through control interface 134 and display interface 133 connected to display screen 102. In some embodiments, display screen 102 is a Liquid Crystal Display (“LCD”), a Thin-Film-Transistor LCD, an Organic Light Emitting Diode display, or any other appropriate display technology. In some embodiments, display interface 133 includes appropriate circuitry for driving the display screen 102 to present graphical and other information to a user. Control interface 134 receives commands from a user and convert them for submission to the processor 130. In preferred embodiments, control interface 134 is a Capacitive or Infrared Touch Panel. In some embodiments, control interface 134 includes home button 105.

In some embodiments, monitor 100 includes external interfaces 138 in communication with processor 130 to enable local communication of monitor 100 with other devices. In preferred embodiments, camera 14, display interface 133, and control interface 134 are connected to processor 130 through external interfaces 138. In some embodiments, camera 106 is also connected to processor 130 through external interface 137. External interfaces 138 can each be adapted to receive a different type of connection, such as USB, HDMI, 15 pin flex ribbon, 30 pin flex ribbon, Ethernet, or any other known connection. Also, several external interfaces 138 can receive the same type of connection. In preferred embodiments, monitor 100 has multiple USB interfaces to receive control interface 134, one or more cameras 14, and an external storage device.

The memory 131 stores information within the monitor 100. The memory 131 can be implemented as one or more of a computer-readable medium or media, a volatile memory unit or units, a non-volatile memory unit or units, or the like. In some embodiments, monitor 100 includes expansion interface 136 for receiving expansion memory 137. In some embodiments, expansion memory 137 is a Single-In-Line Memory Module card interface that provides extra storage space for monitor 100, or stores application or other information for monitor 100. In other embodiments, expansion memory 137 includes instructions to carry out or supplement the processes described above.

In preferred embodiments, software is tangibly embodied in an information carrier. The software contains instructions that, when executed, perform one or more of the processes described above. The information carrier is a computer-readable medium, such as memory 131, expansion memory 137, memory on processor 130, or a propagated signal received by communication interface 132 or external interfaces 138.

Communication interface 132 permits monitor 100 to communicate with other devices through a wired or wireless connection. In some embodiments, communication interface 132 includes digital signal processing circuitry. Preferably, communication interface 132 permits wireless communication through a Wi-Fi transceiver, a Bluetooth transceiver, or both. In some embodiments, communication interface 132 permits wired communication through an external interface 138 adapted to connect to an Ethernet cable. In some embodiments, communication interface 132 includes a radio-frequency transceiver to provide for various other communication modes, such as GSM voice calls, SMS, EMS, or MMS messaging, among others. In some embodiments, communication interface 132 includes a Global Positioning System transceiver to provide navigational and locational data to monitor 100, which can communicate that data to server 30.

In preferred embodiments, monitor 100 includes audio codec 135 for audio communication, Audio codec 135 generates audible sound for a user through a speaker, such as sound communicated to monitor 100 by the instructor. In some embodiments, audio codec 135 receives audible sounds from the user and convert the sounds to useable digital information.

Those skilled in the art will appreciate variations of the above-described embodiments that fall within the scope of the invention. Thus, the invention is not limited to the specific examples and illustrations discussed above, but only by the following claims and their equivalents.

What is claimed is:

1. A system for providing instructional training to a user operating an exercising machine comprising:
a processor connected to the exercise machine;
a display screen connected to the processor;
a memory connected to the processor; and
at least one camera connected to the processor;
wherein the processor includes software instructions to:
receive from the at least one camera a side profile view video feed of the user;
receive, either from the memory or from a server in communication with the system via a network, a side profile view video of an instructor operating a second exercise machine; and
display the side profile view video feed of the user and the side profile view video of the instructor simultaneously on the display screen.

2. The system of claim 1, herein the processor further includes software instructions to:
receive from the at least one camera a front view video feed of the user; and
display the front view video feed of the user, the side profile view video feed of the user, and the side profile video of the instructor simultaneously on the display screen.

3. The system of claim 1, wherein the processor further includes software instructions to:
receive exercise form correction cues from an instructor;
render the exercise form correction cues as a graphical overlay; and
display the graphical overlay on the displayed side profile view video feed of the user.

4. The system of claim 1; wherein the processor further includes software instructions to:
analyze the user's exercise form and the instructor's exercise form;
generate exercise form correction cues;
render the exercise form correction cues as a graphical overlay; and
display the graphical overlay on the displayed side profile view video feed of the user.

5. The system of claim 1; wherein the processor further includes software instructions to:
receive performance data from the exercise machine;
receive, either from the memory or from the server, performance data from each of a plurality of exercisers operating respective exercise machines;
organize the user and the plurality of exercisers into teams; and
calculate team performance data for each team.

6. The system of claim 5, wherein the processor further includes software instructions to:
receive, either from the memory or from the server, side profile view videos of the user's teammates; and
display the side profile view video feed of the user, the side profile view videos of the user's teammates, and the side profile view video of the instructor simultaneously on the display screen.

7. The system of claim 5, wherein the processor further includes software instructions to:
calculate a comparison of each team's team performance data;
render the comparison as a graphically simulated race; and
display the graphically simulated race on the display screen.

8. A system for providing live exercise instruction comprising:
an instructor-input terminal;
one or more servers configured for coordinating communication via a network between the instructor-input terminal and at least one client monitor;
software executing on the one or more servers, containing instructions to:
receive a side profile view video feed of an exerciser from the at least one client monitor as captured by at least one camera associated with the at least one client monitor;
transmit a side profile view video feed of the instructor to the at least one client monitor;
display the side profile view video feed of the exerciser and the side profile view video feed of the instructor simultaneously on a display screen of the instructor-input terminal;
receive exercise form correction cues; and
transmit the exercise form correction cues to the at east one client monitor.

9. The system of claim 8, wherein the at least one client monitor comprises software instructions to:
receive the side profile view video feed of the exerciser;
receive a front view video feed of the exerciser as captured by the at least one camera associated with the client monitor;
receive the side profile view video feed of the instructor; and
display the front view video feed of the exerciser, the side profile view video feed of the exerciser, and the side profile view video feed of the instructor simultaneously on a display screen of the client monitor.

10. The system of claim 8, wherein the exercise form correction cues are received from the instructor-input terminal after being input by an instructor, and wherein the software further comprises instructions to:
render the exercise form correction cues as a graphical overlay; and
transmit the graphical overlay to the at least one client monitor for display on the side profile view video feed of the exerciser.

11. The system of claim 8, wherein the software further comprises instructions to:
analyze the exerciser's exercise form and the instructor's exercise form;
generate exercise form correction cues;
render the exercise form correction cues as a graphical overlay; and
transmit the graphical overlay to the at least one client monitor for display on the side profile view video feed of the exerciser.

12. The system of claim 8, wherein the software further comprises instructions to:
receive performance data from each of a plurality of client monitors;
receive side profile view video feeds of exercisers from each of the plurality of client monitors;
organize the exercisers into teams; and
calculate team performance data for each team.

13. The system of claim 12, wherein each of the plurality of client monitors comprises software instructions to:
receive the side profile view video feed of the respective exerciser;
receive the side profile view video feeds of the respective exerciser's teammates;
receive the side profile view video feed of the instructor; and
display the side profile view video feeds of the respective exerciser, the respective exerciser's teammates, and the instructor simultaneously on a display screen of the client monitor.

14. The system of claim 12, wherein each of the plurality of client monitors further comprises software instructions to:
receive each team's team performance data;
calculate a comparison of each team's team performance data;
render the comparison as a graphically simulated race; and
display the graphically simulated race on the display screen of the client monitor.

15. The system of claim 8, wherein the software further comprises instructions to:
receive performance data from each of a plurality of client monitors;
receive side profile view video feeds of exercisers from each of the plurality of client monitors; and
assign each exerciser at least one race opponent exerciser;
wherein each of the plurality of client monitors comprises software instructions to:
receive the side profile view video feed of the respective exerciser;
receive the side profile view video feed of the respective exerciser's at least one race opponent exerciser;
receive the side profile view video feed of the instructor;
display the side profile view video feeds of the respective exerciser, the respective exerciser's at least one race opponent exerciser, and the instructor simultaneously on a display screen of the client monitor;
receive the performance data of the respective at least one exerciser's race opponent exerciser;
calculate a comparison of the performance data of the respective exerciser and the respective exerciser's at least one race opponent exerciser;
render the comparison as a graphically simulated race; and
display the graphically simulated race on the display screen of the client monitor.

16. A method of providing instructional training to a user of a first exercise machine participating in a live exercise class comprising:
capturing a side profile view video feed of the user operating the first exercise machine;
communicating the side profile view video feed of the user to a first user device connected to the first exercise machine;
capturing a side profile view video feed of an instructor operating a second exercise machine;
communicating the side profile view video feed of the instructor to the first user device; and
displaying the side profile view video feed of the user and the side profile view video feed of the instructor simultaneously on a display screen of the first user device.

17. The method of claim 16, further comprising:
capturing a front view video feed of the user operating the first exercise machine;
communicating the front view video feed of the user to the first user device; and
displaying the front view video feed of the user, the side profile view video feed of the user, and the side profile view video feed of the instructor simultaneously on the display screen of the first user device.

18. The method of claim 16, further comprising:
receiving exercise form correction cues on the first user device;
rendering the exercise form correction cues as a graphical overlay; and
displaying the graphical overlay on the displayed side profile view video feed of the user.

19. The method of claim 16, further comprising:
analyzing the user's exercise form and the instructor's exercise form;
generating exercise form correction cues;
rendering the exercise form correction cues as a graphical overlay; and
displaying the graphical overlay on the displayed side profile view video feed of the user.

20. The method of claim 16, wherein the user is remotely located from the instructor.
